(19) United States
(12) Patent Application Publication
(10) Pub. No.: US 2008/0272550 A1
(43) Pub. Date: Nov. 6, 2008

(54) Hydraulic tubing fitting seal

(75) Inventor: Robert J. Topping, Longmont, CO (US)

Correspondence Address: ROCHE PALO ALTO LLC;PATENT LAW DEPT. M/S A2-250, 3431 HILLVIEW AVENUE, PALO ALTO, CA, 94304, US

(73) Assignee: Roche Colorado Corporation

(21) Appl. No.: 12/151,221

(22) Filed: May 2, 2008

Related U.S. Application Data
(60) Provisional application No. 60/927,265, filed on May 2, 2007.

(51) Int. Cl. F16L 23/22

(52) U.S. Cl. 277/314; 277/626

(57) ABSTRACT

A seal for a flared end fitting, wherein the fitting includes a male portion having a tapered end, a female portion having a coordinated shape to the male portion, and a flow passage axially disposed in both female and male portions, the seal comprising: a frustoconical portion having an inner end and an outer end, wherein the inner end is circumferentially attached to one end of a cylindrical portion having two ends and coaxially disposed about the cylindrical portion, the cylindrical portion forms a flow passage through the seal, the frustoconical and cylindrical portions form a cavity that fits on the tapered end of the male portion of the fitting, and the cylindrical portion of the seal fits into the flow passage of the male portion of the fitting. A method of sealing a flared end fitting.

### PRIORITY

The present non-provisional patent application claims benefit from U.S. Provisional Patent Application having Ser. No. 60/927,265, filed on May 2, 2007, by Topping, and titled HYDRAULIC TUBING FITTING SEAL, wherein the entirety of said provisional patent application is incorporated herein by reference.

### FIELD OF THE INVENTION

The present invention generally relates to hydraulic tubing fittings or adapters used to couple hydraulic tubing, and more particularly to a seal for hydraulic tubing fittings, which is used to eliminate leakage at coupling sites.

### BACKGROUND OF THE INVENTION

Hoses, or tubing, are employed as flow conduit in fluid flow systems. Such tubing may be joined or coupled in such systems using adapters/fittings. Such adapters or fittings are generally made of metal (e.g., stainless steel). One established type of adapter or fitting includes a flare on an end of one tube that makes up a female portion abutted against a corresponding male portion connected to the end of another tube, which connects the tubes and effects a positive seal. A compression nut and corresponding threads are usually used together to produce an axial force on the male and female portions so that surfaces of the portions are placed under load in metal-to-metal contact with each other to create the seal.

Various angles of flare have been employed in the United States and around the world in such fittings. In particular, some commonly used flared angles include precisely machined angles of 12, 30, 37 and 45 degrees, for example.

One specific example of a flared fitting utilizing metal-to-metal contact that is widely used is a fitting having a 37 degree flared or frustoconical surface, which is known as a “Joint Industry Conference (JIC) fitting.” The JIC fitting was created by an organization of fitting manufacturers in order to standardize the manufacture of 37 degree flared angle fittings that were originally developed by the United States Air Force before World War II. The JIC also involved the Society of Automotive Engineers (SAE) in the process of standardizing the fitting, with the fitting becoming part of SAE J514 in 1950. The 37 degree flared fitting later became an International Organization for Standardization (ISO) standard, ISO 8434, in 1986, which was replaced by ISO 8434-2 in 1996.

FIG. 1 illustrates a side view of a JIC fitting for use in a fluid system, such as in an aircraft hydraulic or fuel system. The fitting 10 includes a male portion 12 and a female portion 14. The exemplary JIC fitting 10 is shown with the male 12 and female 14 portions separated from one another, detached or uncoupled. The male portion 12 resembles a cylindrical tube and includes a flow passage (not shown) that runs axially throughout the portion 12 and that allows for transport of fluids along its length and through its center. A seal is obtained by mating of a 37 degree frustoconical or beveled surface 16 on the outside end 11 of the male portion 12 with a corresponding 37 degree frustoconical or beveled surface 18 (not seen in Figure) inside the female portion or member 14. The female portion 14 also resembles a cylindrical tube with a flow passage running axially throughout. Threads 20 on the male member 12 mate threads in the female member (not shown) which function to draw the two beveled surfaces 16, 18 together when the two members are rotated with respect one another using hex heads 15, 32 on the female and male portions 14, 12, respectively. The mated threads function to hold the two portions 12, 14 together in order to help effect a seal at the two surfaces 16, 18. The fitting 10 holds and seals two sections of tubing together, with a first section 13 being attached to the female portion 14 and a second section (not shown) being mated to the male portion 12 using threads 17.

JIC fittings are used particularly in high pressure systems and are generally tight fittings that do not commonly experience leakage when connected for the first time. Heavy torque may be applied during coupling, however, which may deform the male portion when it is axially forced into the female fitting after the sealing surfaces already abut each other. This possible damage to the fitting during assembly can prevent an effective seal from being formed in the fitting. Even if an effective seal is formed in a fitting the first time it is used, damage may be caused to the fitting during a disassembly, for example, that could prevent an effective seal from being produced in the fitting after subsequent reassembly. As a result, many fittings are not reused and are only used once, which is costly. The seal in JIC fittings is formed with smooth sealing surfaces. Blemishes may easily be introduced to the smooth surfaces prior to, during or after assembly that may affect the seal. Also, foreign matter may contaminate the surfaces prior to, during or after assembly. As a result of such deformation, blemishes and contamination, a good seal may be prevented from being formed, which may allow fluid leakage. Additionally, metal “creep” and cold flow over a duration of time may result in dimensional changes that permit leakage in such fittings.

One known modification to a hydraulic tubing fitting used to reduce or prevent fluid leakage is to machine an O-ring groove into a male portion and to include an O-ring in the groove. The purpose of the O-ring is to help seal the metal-to-metal surface between the male portion and a female portion. A problem with such a modification, however, is that the groove actually weakens the fitting. Additionally, O-rings work well for parallel surfaces, but do not perform as well to prevent leaks between beveled surfaces as in JIC fittings.

Another known method used to prevent leaks in hydraulic tubing fittings is to apply a layer of Teflon™ tape between female and male portions of such a fitting. The tape is held in place between mated threads of the female and male portions. A problem with using Teflon™ tape, however, is that the tape may become dislodged and contaminate the fluid running through the tubing connected using the fitting. Another problem is that Teflon™ tape is inconvenient to apply. Additionally, the tape may tear or otherwise be ineffective at sealing the connection.

Thus, a substantial need exists for an effective device and/or method for connecting and sealing JIC fittings or other flared end fittings, and that may allow the fittings to be reused with effective sealing. It is desirable for such a device to be convenient to apply and economical, as well as effective.

### SUMMARY OF THE INVENTION

The present invention teaches a device and a method used to seal a hydraulic tubing fitting or adapter to form a superior connection between sections of tubing used in high pressure systems (e.g., a hydraulic fluid flow system). The purpose of such a device and/or method is to effectively seal such a connection in order to prevent leakage from such a system and to prevent contamination of the system. In particular, a seal is used that cooperates with a fitting having frustoconical surfaces on male and female portions, such as a JIC fitting, and fits between such portions in order to provide an effective seal. Such a seal is effective even if there is damage to the male and female portions of the fitting. In particular, the seal fits between the beveled or frustoconical surfaces of the male and female portions of the JIC fitting, and is held in place by the two portions being connected to each other (e.g., using mating threads on the two portions). It is, however, contemplated that the present invention may be used for any flared end fittings, including, but not limited to, JIC fittings.

An advantage of using the device and method of the present invention is that flared fittings connecting tubing in high pressure systems may be effectively sealed even if such fittings include blemishes, deformations and contaminating matter on sealing surfaces of the fittings. An effective seal can result from using the seal on a fitting that is being reused. Additionally, the seals are economical and easy to use. The seals are also easy to replace and are reusable. A further advantage is that the seals are solid enough to be held in place on the fitting so they will not become dislodged and contaminate a fluid flow system into which they are placed.

In one aspect, the present invention is a seal for a flared end fitting, wherein the fitting includes a male portion having a tapered end, a female portion having a coordinated shape to the male portion, and a flow passage axially disposed in both female and male portions, the seal comprising: a frustoconical portion having an inner end and an outer end, wherein the inner end is circumferentially attached to one end of a cylindrical portion having two ends and coaxially disposed about the cylindrical portion, the cylindrical portion forms a flow passage through the seal, the frustoconical and cylindrical portions form a cavity that fits on the tapered end of the male portion of the fitting, and the cylindrical portion of the seal fits into the flow passage of the male portion of the fitting. The fitting may be a JIC fitting. The seal may comprise Teflon™. The fitting may include a seal surface on each male and female portion where the portions substantially contact each other when fit together, and the frustoconical portion of the seal is compressed between male and female portions of the fitting such that the frustoconical portion substantially contacts the seal surfaces of both male and female portions. The male and female portions of the fitting may substantially contact each other at an angle from a central axis of the fitting, and the frustoconical portion and cylindrical portion of the seal may be attached at an angle that is substantially the same as the angle of the seal surfaces of the fitting from the central axis. The female portion of the fitting may include an internally threaded engaging portion, the male portion of the fitting may include an externally threaded portion that mates in sealing contact with the female portion, and the frustoconical portion of the seal may be compressed by threadedly engaging the threaded engaging portions of the male and female portions.

Another aspect of the present invention is a method of sealing a flared end fitting, comprising the steps of: providing a fitting that comprises a male portion having a tapered end, a female portion having a coordinated shape to the male portion, and a flow passage axially disposed in both female and male portions, wherein the female and male portions include means for engaging the two portions; providing a seal comprising a frustoconical portion having an inner end and an outer end, wherein the inner end is circumferentially attached to one end of a cylindrical portion having two ends and coaxially disposed about the cylindrical portion, the cylindrical portion forms a flow passage through the seal, the frustoconical and cylindrical portions form a cavity that fits on the tapered end of the male portion of the fitting, and the cylindrical portion of the seal fits into the flow passage of the male portion of the fitting; placing the seal on the tapered end of the male portion of the fitting with the cylindrical portion of the seal extending into the flow passage of the male portion of the fitting; engaging the male and female portions of the fitting together; and compressing the seal between the male and female portions of the fitting.

### BRIEF DESCRIPTION OF THE DRAWINGS

The above-mentioned and other advantages of the present invention, and the manner of attaining them, will become apparent and the invention itself will be better understood by reference to the following description of the embodiments of the invention taken in conjunction with the accompanying drawings, wherein like structure is referred to by like numerals throughout the figures, and wherein:

FIG. 1 is a side view illustration of disassembled male and female portions of a JIC fitting;

FIG. 2 is a side view of the disassembled JIC fitting of FIG. 1 and shown including a seal in accordance with the present invention;

FIG. 3 is a sectional view of a tubing fitting, including female and male portions of the connection, and also including a sectional view of a seal, in accordance with the present invention, shown retained between the male and female portions;

FIG. 4 is a schematic illustration of a seal in accordance with the present invention;

FIG. 5 is a side view illustration of a seal in accordance with the present invention; and

FIG. 6 is a bottom view illustration of a seal in accordance with the present invention.

### DETAILED DESCRIPTION OF PRESENTLY PREFERRED EMBODIMENTS

Although the present application focuses on devices and/or methods for sealing JIC fittings, the present application contemplates using the present invention to effectively seal any type of flared end fitting or adapter. In particular, the focus will be on sealing flared end fittings in hydraulic fluid systems. However, it is contemplated that the present invention may be used in any type of system in which flared end fittings are used.

With reference to the accompanying figures, wherein like components are labeled with like numerals throughout the figures, an illustrative seal for JIC fittings and other flared end fittings is disclosed, taught and suggested by the multiple embodiments.

The embodiments of the present invention described below are not intended to be exhaustive or to limit the invention to the precise forms disclosed in the following detailed description. Rather the embodiments are chosen and described so that others skilled in the art may appreciate and understand the principles and practices of the present invention.

The principles of the present invention may be practiced in any instance in which it is desired to effectively seal a flared end tubing fitting or adapter that connects sections of tubing in a high pressure system (e.g., hydraulic fluid system). In particular, the present invention may be used to seal such fittings that may have been disconnected and reconnected subsequent to an initial connection, and that may have incurred damage. Again, for purposes of explanation, the invention will generally be described with regard to a seal for a JIC fitting. However, the present invention may be used with other flared end fittings. Some examples of other possible fittings include, but are not limited to, SAE 45 degree flare couplings, Parker Triple Thread (PTT) 30-degree flare couplings and Japanese Industrial Standardization (JIS) 30 degree flare parallel thread couplings.

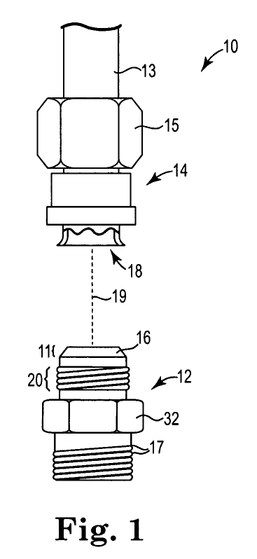

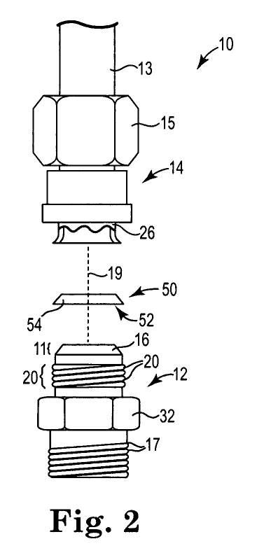

For purposes of illustration, the present invention will be described with respect to a representative fitting 10 shown disassembled in FIGS. 1 and 2, with FIG. 2 including a seal 50, in accordance with the present invention. FIG. 2 shows how the seal 50 can fit and can be retained between male 12 female 14 portions of the fitting 10. The purpose of the seal 50, shown in FIG. 2, is to effectively seal the JIC fitting 10 between the male and female portions 12, 14. The seal 50 fits over a beveled or frustoconical surface 16 on a tapered end 11 of an extension 34 of the male portion 12. The female portion 14 is connected to the male portion by fitting over and surrounding the male extension 34 and the seal 50. Threads 20 on the male extension 34 preferably mate with corresponding threads in the inside of female portion 14 (not shown) to secure the two portions 12, 14 together with the seal 50 retained between the portions 12, 14. A hex head 15 or the like may be provided on female member 14 to allow tightening with a wrench. As shown, female portion 14 is connected, opposite the seal 50 and male portion 14, to a section of tubing 13. Means for attachment of the male member 12 to another section of tubing (not shown), such as by using threads 17 that mate with threads on the section of tubing, for example, may also be provided. A hex head 32 or the like may be provided on the male portion 12 for tightening purposes. Other similar arrangements are also contemplated that would allow the portions 12, 14 of the fitting 10 to be attached to sections of tubing opposite where the portions 12, 14 are joined or connected using the seal 50.

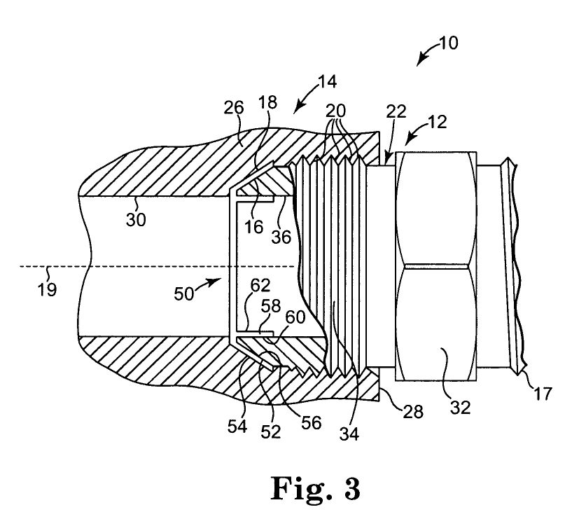

FIG. 3 is a partial sectional view of an assembled tubing fitting 10 (e.g., JIC) including seal 50. The fitting 10 comprises a female portion 14 including a threaded port 22 and a male portion 12 including threads 20. Female portion 14 of the fitting 10 includes a port body 26 with the threaded port 22 extending inwardly from an end face 28 to form the internally threaded port 22. The port body 26 also has provided therein a flow passage 30, which is smaller in diameter than that of threaded port 22, and a frustoconical or beveled seal surface 18 located between threaded port 22 and flow passage 30. Preferably, female portion 14 is a standard female member that is part of a JIC fitting. Male portion 12 of the fitting 10 is adapted to mate in sealing contact with the threaded port 22 of the female portion 14 along frustoconical surface 16. Male portion 12 is also preferably a standard male member that is part of a JIC fitting. Male portion 12 preferably includes a hexagonal nut portion 32 (i.e., hex head) and an externally threaded male extension 34 that can threadedly engage the internally threaded port 22. Male portion 12 also has an internal flow passage 36 that is coaxial with and can communicate with the flow passage 30 of the female portion 14 while in an assembled condition of connection. The flow passages 30, 36 may preferably be cylindrical in shape, although other shapes are also contemplated. Male portion 12 also has a standard frustoconical or beveled seal surface 16 constructed and arranged to be positioned in sealing contact with seal surface 18 of female portion 14 by the threaded engagement between threaded portions 20 and 22. A mating angle, at which the male seal surface 16 and female seal surface 18 may mate (without seal 50 present), is 37 degrees for a JIC fitting. This angle is taken with respect to the central axis (indicated by 17 in Figures) of the fitting. Other mating angles may, however, be employed in the present invention. Additionally, components used to connect the male and female portions 12, 14 of the fitting other than the nuts and threads described and shown are also contemplated by the present invention. Any such components may be used in the present invention in order to bring the surfaces 16 and 18 into sealing contact with seal 50 and retain such sealing contact.

FIG. 3 also includes a sectional view of an embodiment of the seal 50 of the present invention. The seal 50 shown has a frustoconical portion 52 that, as shown, contacts the female portion beveled surface 18 at a first surface 54 and contacts the male portion beveled surface 16 at a second surface 56. The seal 50 also includes a cylindrical portion 58 that is attached to the frustoconical portion 52 of the seal 50 towards the interior of the frustoconical portion 52 or seal 50. With regard to the fitting 10, the cylindrical portion 58 attaches to the frustoconical portion 52 of the seal 50 distal to the male extension 34 of the fitting 10 and extends and preferably rests against sides of the flow passage 36 of the male portion 12 and further extends generally parallel to an axis running through the flow passage 36. A purpose of the cylindrical portion 58 is to help to hold the seal 50 in place between the male and female 12, 14 portions, so that an effective seal can be formed between the male and female portions 12, 14. The diameter of the cylindrical portion 58 is preferably slightly less than the diameter of the flow passage 36 of the male portion 12. Cylindrical portion 58 may be relatively smooth such that it is able to slide and snugly fit into flow passage 36 of the male portion 12. However, alternatively, cylindrical portion 58 may be threaded to mate and engage with possible threads located on the walls of the flow passage 36.

Cylindrical portion 58 is preferably shaped to fit in the flow passage 36 of the male portion 12. Since the flow passage 36 may have alternative shapes to the cylindrical one shown in FIG. 3, the cylindrical portion 58 may similarly be alternatively shaped.

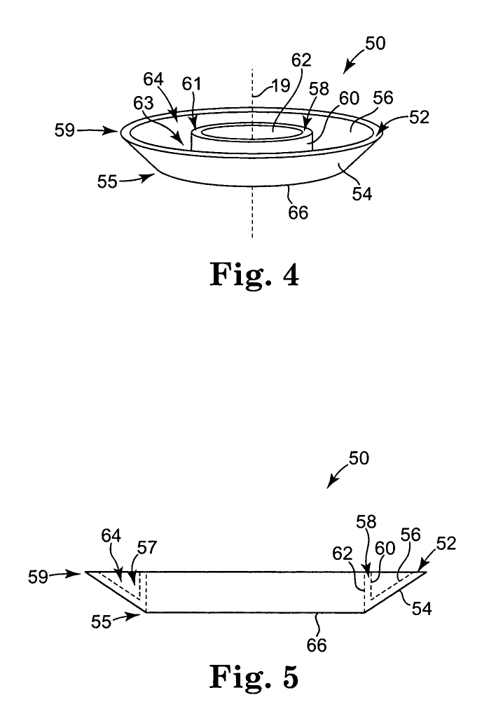

FIG. 4 is a schematic illustration of an embodiment of the seal 50 of the present invention. The seal 50 as shown is configured to fit over a male extension or portion of a flared end fitting 10 such that the tapered end (11 in FIGS. 1 and 2) of the male portion 12 can fit inside the cavity 64. The seal 50 is also configured so that a female portion 14 of the fitting 10 can fit over the seal 50 when it is assembled together with the male portion 12. The seal 50 includes a frustoconical portion 52 that can contact a seal surface of the female portion 14 of the flared end fitting 10 at a first surface 54 and can contact a seal surface of the male portion 12 at a second surface 56. The frustoconical portion 52 has two ends, which include an inner end 55 and an outer end 59, with the terms “inner” and “outer” relating to how the ends relate to a central flow axis 19 through the seal 50, with the central flow axis 19 being inside the seal 50. The frustoconical portion 52 is circumferentially attached to one end 63 of a cylindrical portion 58 that has two ends 61, 63, with the frustoconical portion 52 being coaxially disposed about the cylindrical portion 58. The frustoconical portion 52 is also connected to the cylindrical portion 58 at an angle, with the angle 57 generally matching the angle that the male and female portions of the fitting meet together at the sealing surfaces, such as 37 degrees for a JIC fitting. Such an angle is taken with respect to the central flow axis 19, as discussed above.

The cylindrical portion 58 preferably fits within a flow passage (36 in FIG. 3) of the male portion 12 of the fitting. The cylindrical portion 58 has a first surface 60 that contacts the wall of the flow passage of the male portion and a second surface 62 that defines a flow passage through the seal 50. Preferably, the cylindrical portion 58 fits in the flow passage of the male portion in order to help hold the seal 50 in place for a more effective seal of the fitting.

The cylindrical portion 58 may have a shape other than the cylindrical one shown. The shape of such a flow passage portion of the seal 50 may have a shape to match the shape of the flow passage of the male portion of the fitting.

FIG. 5 shows a side view illustration of an embodiment of the seal 50 of the present invention. The dashed lines show a cross sectional view of the frustoconical and cylindrical portions 52, 58 and how they meet at a desired angle 57 to generally match that of a flared end fitting. The cavity 64 that is defined by the frustoconical 52 and cylindrical 58 portions is formed in order to accommodate an end of a male portion of a flared end fitting.

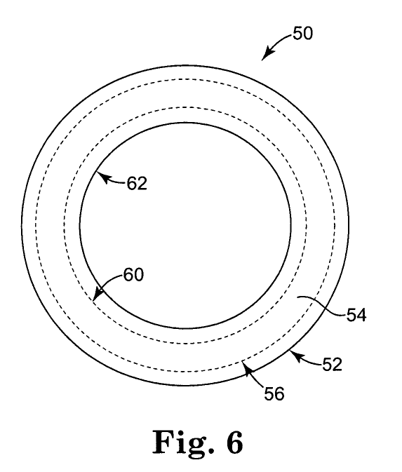

FIG. 6 shows a view of the seal 50 of FIG. 5 from the bottom 66 of the seal 50.

The seal 50 may be machined or molded (e.g., injection molding), or made using any other similar process. The seal 50 is preferably precisely machined such that the angle of the frustoconical portion 52 with respect to the cylindrical (or other shaped) portion 58 precisely conforms with mated male and female portion surfaces 16, 18 and the flow passage 36 of the male portion 12. The seal 50 is secured in place in a fitting by mating male and female portions 12, 14 and the seal 50 preferably remains stable until fitting 10 is disassembled.

Preferably, the seal 50 is formed from one piece of material. However, it is also possible that the seal may be made by attaching separately formed pieces together.

The seal 50 may be made from any material suitable for providing a sealed connection. Preferably, the seal 50 comprises a material of sufficient rigidity such that the seal 50 may fit in the fitting without being dislodged from between male and female portions of the fitting while fluid, for example, flows through the fitting. Additionally, preferably, the seal 50 comprises a material that is compatible with, or inert to, all anticipated chemicals and materials that could come into contact with the seal 50 during use. The seal 50 may comprise a single material, a blend of materials, composite material, and the like. Preferably, the material has a certain Durometer Hardness so as to allow the seal 50 to be retained in its desired position between male 12 and female 14 portions of a fitting 10. One particularly preferred material for the seal 50 is Teflon™. Another possible material is a deformable but noncompressible elastomeric material, such as a natural or synthetic rubber. The material used for the seal 50 is not, however, limited to the materials listed and may comprise any suitable material for forming a seal between male and female portions 12, 14 of any flared fitting where it is considered useful to seal the fitting with a seal of the present invention.

Preferably, for a JIC fitting, the seal 50 has an outside diameter of about 37 to 39 mm and an inside diameter of about 24 mm. The seal 50 preferably snugly fits a male portion 12 having a flow passage 36 diameter of about 27 mm. Also, preferably, the seal 50 has a height of 6 mm. These dimensions are preferred, however, and apply for a seal mating to a JIC fitting. Different dimensions of the seal 50 are, however, contemplated for other fittings.

Referring to FIGS. 2 and 3, in order to use the seal 50, the fitting 10 is disassembled, and the seal 50 is placed on the end 11 of the extension 34 of the male portion 12 of the fitting 10 with the cylindrical portion 58 fitting inside the flow passage 36 of the male portion 12. The cylindrical portion 58 extends into a portion of the flow passage 36 in the male portion 12 of the fitting 10 in order to allow the seal 50 to be securely held in place in the flow passage 36 when the male 12 and female 14 portions of the fitting 10 are compressed together. Preferably, the cylindrical portion 58 fits snugly in the flow passage 36 of the male portion 12 of the fitting 10. If the cylindrical portion 58 of the seal 50 includes threads, then the seal 50 is screwed onto the male portion 12 such that threads on the seal 50 mate with threads in the flow passage 36 of the male portion 12. The frustoconical portion 52 of the seal 50 is placed over the male portion 12 such that portion 52 contacts sealing surface 16 at a surface 52. The female portion 14 is then placed over the seal 50 and extension 34 of the male portion 12. The male 12 and female 14 portions are then threadedly, or otherwise, engaged, with the seal 50 being retained between the two portions 12, 14. The sealing surface 18 of the female portion 14 then contacts the surface 54 of the seal 50. The frustoconical portion 52 of the seal 50 is compressed between sealing surfaces 16 and 18 to produce an effective sealing relationship. The seal 50 preferably conforms itself to any irregularities in the surfaces 16, 18, such as scratches, dents, etc., and will produce an effective seal.

Hydro-testing and flow performance testing was performed on seals of the present invention that mated with JIC fittings. A JIC fitting was assembled with a seal of the present invention being placed between male and females portions of the fitting. Water was moved through the fitting using hydraulic pressures of up to about 200 psi. The fitting and seal combination was checked for visible leaks. No leaks were observed.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by included claims.

What is claimed is:

1. A seal for a flared end fitting, wherein the fitting includes a male portion having a tapered end, a female portion having a coordinated shape to the male portion, and a flow passage axially disposed in both female and male portions, the seal comprising:
a frustoconical portion having an inner end and an outer end, wherein the inner end is circumferentially attached to one end of a cylindrical portion having two ends and coaxially disposed about the cylindrical portion, the cylindrical portion forms a flow passage through the seal, the frustoconical and cylindrical portions form a cavity that fits on the tapered end of the male portion of the fitting, and the cylindrical portion of the seal fits into the flow passage of the male portion of the fitting.

2. The seal of claim 1, wherein the fitting is a JIC fitting.

3. The seal of claim 1, wherein the seal comprises Teflon™.

4. The seal of claim 1, wherein the fitting includes a seal surface on each male and female portion where the portions substantially contact each other when fit together, and the frustoconical portion of the seal is compressed between male and female portions of the fitting such that the frustoconical portion substantially contacts the seal surfaces of both male and female portions.

5. The seal of claim 4, wherein the male and female portions of the fitting substantially contact each other at an angle from a central axis of the fitting, and the frustoconical portion and cylindrical portion of the seal are attached at an angle that is substantially the same as the angle of the seal surfaces of the fitting from the central axis.

6. The seal of claim 4, wherein the female portion of the fitting includes an internally threaded engaging portion, the male portion of the fitting includes an externally threaded portion that mates in sealing contact with the female portion, and the frustoconical portion of the seal is compressed by threadedly engaging the threaded engaging portions of the male and female portions.

7. A method of sealing a flared end fitting, comprising the steps of:
providing a fitting that comprises a male portion having a tapered end, a female portion having a coordinated shape to the male portion, and a flow passage axially disposed in both female and male portions, wherein the female and male portions include means for engaging the two portions;
providing a seal comprising a frustoconical portion having an inner end and an outer end, wherein the inner end is circumferentially attached to one end of a cylindrical portion having two ends and coaxially disposed about the cylindrical portion, the cylindrical portion forms a flow passage through the seal, the frustoconical and cylindrical portions form a cavity that fits on the tapered end of the male portion of the fitting, and the cylindrical portion of the seal fits into the flow passage of the male portion of the fitting;
placing the seal on the tapered end of the male portion of the fitting with the cylindrical portion of the seal extending into the flow passage of the male portion of the fitting;
engaging the male and female portions of the fitting together; and
compressing the seal between the male and female portions of the fitting.

8. The method of claim 7, wherein the fitting is a JIC fitting.

9. The method of claim 7, wherein the seal comprises Teflon™.

10. The method of claim 7, wherein the fitting includes a seal surface on each male and female portion where the portions substantially contact each other when fit together, and the frustoconical portion of the seal is compressed between male and female portions of the fitting such that the frustoconical portion substantially contacts the seal surfaces of both male and female portions.

11. The method of claim 10, wherein the male and female portions of the fitting substantially contact each other at an angle from a central axis of the fitting, and the frustoconical portion and cylindrical portion of the seal are attached at an angle that is substantially the same as the angle of the seal surfaces of the fitting from the central axis.

12. The method of claim 7, wherein the female portion of the fitting includes an internally threaded engaging portion, the male portion of the fitting includes a externally threaded portion that mates in sealing contact with the female portion, and the frustoconical portion of the seal is compressed by threadedly engaging the threaded engaging portions of the male and female portions.
